(19) United States
(12) Patent Application Publication
(10) Pub. No.: US 2026/0305868 A1
(43) Pub. Date: Oct. 8, 2026

(54) MICROWAVE POT

(71) Applicant: HUAMIN PENG, Foshan City (CN)

(72) Inventor: HUAMIN PENG, Foshan City (CN)

(21) Appl. No.: 19/658,656

(22) Filed: Apr. 26, 2026

Related U.S. Application Data
(63) Continuation of application No. PCT/CN2025/088990, filed on Apr. 15, 2025.

(30) Foreign Application Priority Data
Apr. 3, 2025 (CN) 202520632512.3

(51) Int. Cl. A47J 36/02; A47J 36/04; A47J 36/06; A47J 45/06

(52) U.S. Cl. CPC A47J 36/027; A47J 36/04; A47J 36/06; A47J 45/06

(57) ABSTRACT

The disclosure discloses a microwave pot. According to the disclosure, by arranging the pot body and the shell of the microwave pot to be detachable and setting the fixing structure inside the shell, the pot body can be fixed in the shell, and high-pressure air can be guided out of the pot from both sides of the fixing structure at the same time, so that the air pressure inside and outside the microwave pot can be balanced in use, the safe pressure relief is realized, and the user experience is improved.

### CROSS-REFERENCE

This application is a continuation of International Application No. PCT/CN 2025/088990 with a filling date of Apr. 15, 2025, designating the United States, now pending, which further claims to the benefit of priority from Chinese Application No. 202520632512.3 with a filing date of Apr. 3, 2025. The content of the aforementioned applications, including any intervening amendments thereto, are incorporated herein by reference.

### TECHNICAL FIELD

The present disclosure relates to the technical field of kitchenware, in particular to a microwave pot.

### BACKGROUND

The common microwave pots with shells on the market are usually provided with a microwave absorption layer on the bottom of the pot body. When the microwave absorption layer absorbs microwave for heating, the air between the shell and the pot body is heated, resulting in high pressure, and there is no effective pressure relief measure, which poses a safety hazard to the common microwave pots with shells on the market.

It can be seen that the prior art still needs improvement and enhancement.

### SUMMARY

The technical problem to be solved by the present disclosure is to provide a microwave pot with the advantage of safe pressure relief to overcome the disadvantages of the prior art.

In order to solve the above technical problems, the technical solution of the present disclosure is:

A microwave pot, including a shell, a pot body, and a pot cover used in conjunction with the pot body, wherein a fixing structure is arranged between the shell and the pot body, the pot body is made of metal, a microwave absorption layer is fixed on a bottom surface of the pot body, a gap is formed between the shell and the pot body by the fixing structure, and hot air between the shell and the pot body is discharged through the gap during microwave heating.

The fixing structure is ribs provided at an inner wall of the shell, and the ribs are in contact with an outer surface of the pot body.

The pot cover is made of metal, a top handle is arranged at the upper end of the pot cover, the edge of the pot cover is sleeved with an insulation ring that is attached to the pot body, exhaust holes are arranged on the pot cover, and the microwave absorbing layer is covered with a silicone ring fastener.

The shell is made of plastic material, the fixing structure is ribs provided at the inner wall of the shell, and the ribs and the pot body are in an interference fit.

A handle is arranged on the shell, and a clamp is arranged on the handle. The fixing structure consists of a protrusion and the clamp. The clamp includes an elastic member, a handle cover, and a substrate piece. The handle cover is fixed on the handle, a first moving groove is provided on the handle cover, the substrate piece slides in the first moving groove, the tail end of the substrate piece is connected to an elastic member, and the elastic member pushes the substrate piece towards the inner cavity of the pot body, such that an end of the substrate piece passes through a first hole of the pot body.

The protrusion is provided on the inner wall of the shell, the handle cover is used to seal a first chamber of the handle, and the two side walls of the first chamber are symmetrically provided with a second sliding groove. The substrate piece includes a guide plate, an end plate, and a pressing part. The guide plate is embedded in the second sliding groove for sliding, an end of the end plate is capable of reciprocating in the first hole, and the pressing part is located above the first moving groove.

A third sliding groove is arranged above the second groove in parallel, the left and right sides of the handle cover is respectively provided with a first hook, the first hook is hooked on the third sliding groove, a back plate is provided at the rear of the handle cover, and the elastic member presses against the back plate.

The elastic member is a V-shaped member, the fork end of the elastic member presses against the back plate, the tip end of the elastic member presses against the end plate, the bottom of the first chamber is provided with a positioning groove, and the handle cover is provided with a second hook capable of hooking onto the positioning groove.

The connecting plate is connected with the end plate and the pressing part, and the connecting plate is located in the first moving groove.

A clamping part is arranged on the inner wall of the shell, the clamping part includes a first limiting groove and a second limiting groove, a limiting protrusion is arranged between the first limiting groove and the second limiting groove, flange portions are arranged on the outer wall of the pot body, and the fixing structure consists of the clamping part and the flange portions.

Adopting the above technical solution has the following advantageous effects:
According to the present disclosure, by arranging the pot body and the shell of the microwave pot to be detachable and setting the fixing structure inside the shell, the pot body can be fixed in the shell, and high-pressure air can be guided out of the pot from both sides of the fixing structure at the same time, so that the air pressure inside and outside the microwave pot can be balanced in use, the safe pressure relief is realized, and the user experience is improved.

### BRIEF DESCRIPTION OF THE DRAWINGS

In order to provide a clearer illustration of the embodiments of the present disclosure or the technical solutions in the prior art, the following will briefly introduce the accompanying drawings required for the description of the embodiments or prior art. It is obvious that the accompanying drawings described below are only exemplary. For ordinary skilled person in the art, other implementation drawings can be derived from the provided drawings without creative labor.

The structure, proportion, size, etc. shown in this specification are only for the purpose of cooperating with the content disclosed in the specification, for the understanding and reading of those familiar with this technology, and are not intended to limit the conditions under which the present disclosure can be implemented. Therefore, it does not have substantive technical significance. Any structural modification, change in proportion, or adjustment in size, without affecting the efficacy and objectives that can be achieved by the present disclosure, should still fall within the scope of the technical content disclosed in the present disclosure.

FIG. 1 is a structural schematic diagram of the microwave pot of the present disclosure;

FIG. 2 is an exploded view of the microwave pot;

FIG. 3 is a structural schematic diagram of the microwave pot of the embodiment 2;

FIG. 4 is a sectional view of the shell in the embodiment 2;

FIG. 5 is an exploded view of the shell in the embodiment 2;

FIG. 6 is a structural schematic diagram of the microwave pot of the embodiment 3;

FIG. 7 is an enlarged view of potion A in FIG. 6.

Reference numbers in the drawings: shell 1, pot body 2, pot cover 3, exhaust hole 4, microwave absorption layer 5, silicone ring fastener 6, rib 7, top handle 8, insulation ring 9, handle 10, protrusion 11, handle cover 12, substrate piece 13, elastic member 14, clamping part 15, flange portion 16, first limiting groove 17, second limiting groove 18, limiting protrusion 19, silicone sealing ring 20.

### DETAILED DESCRIPTION OF THE EMBODIMENTS

The specific embodiments of the present disclosure will be further illustrated in conjunction with the accompanying drawings. It should be noted that the description of these embodiments is intended for better understanding the present disclosure, but does not constitute a limitation of the present disclosure. In addition, the technical features involved in the various embodiments of the present disclosure described below can be combined with each other as long as they do not conflict with each other.

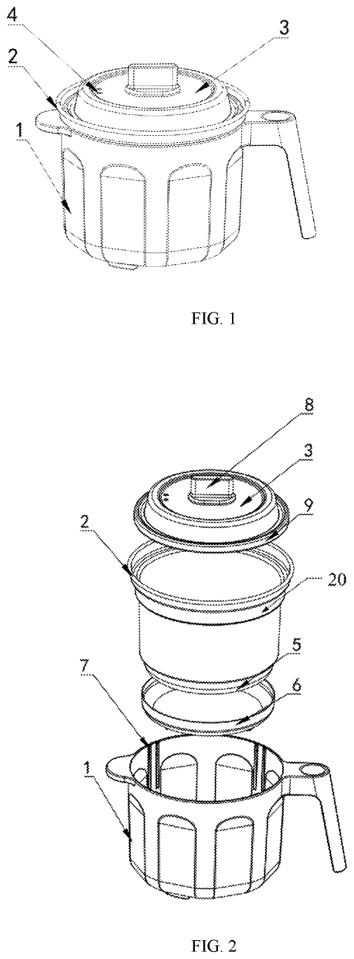

Referring to FIGS. 1-6, the present disclosure discloses a microwave pot.

### Embodiment 1

Please refer to FIGS. 1-2, a microwave pot includes a shell 1, a pot body 2, and a pot cover 3 used in conjunction with the pot body 2. An exhaust hole 4 is arranged on the pot cover 3, and the pot body 2 is made of metal. The bottom surface of the pot body 2 is fixedly provided with a microwave absorption layer 5, which is covered with a silicone ring fastener 6 to fixed the microwave absorption layer 5 on the bottom surface of the pot body 2. A fixing structure is arranged inside the shell 1, a gap is formed between the inner wall of the shell 1 and the outer wall of the pot body 2 by the fixing structure, and the pot body 2 is fixed inside the shell 1 through the fixing structure. During microwave heating, the microwave absorption layer 5 absorbs microwave energy and converts it into thermal energy to heat the bottom of the pot, allowing the food inside the pot to be cooked. At the same time, by providing the silicone ring fastener 6, the heat generated by the microwave absorption layer 5 also causes the air between the pot body and the shell to be heated and the pressure to increase. Due to the design having a fixed structure, the high-pressure air generated by the microwave pot can be discharged from the gap between the outer wall of the pot body 2 and the inner wall of the shell 1 along the fixing structure.

Specifically, the fixing structure is ribs 7, which are in contact with the outer surface of the pot body 2. There is an interference fit between the pot body and the ribs, which fixes the pot body 2 inside the shell 1, so that the pot body 2 will not shake during heating to avoid food splashing out. When cleaning is needed, the pot body can also be taken out of the shell, which is convenient for cleaning. Meanwhile, due to the ribs 7 between shell 1 and pot body 2, the high-pressure air generated during microwave heating can be discharged from the gap between pot body 2 and shell 1 along both sides of ribs 7, achieving safe pressure relief of the microwave pot, so that user safety is ensured.

In a more preferred solution, the pot body is sleeved by a silicone sealing ring 20, and there is an interference fit between the silicone sealing ring and the ribs, which can fix the pot body inside the shell. With the silicone sealing ring, the shell does not need to undergo significant deformation when fitting with the pot body, effectively prolonging the service life of the shell and improving the user experience.

Further, for offering the convenience to users, the pot cover 3 is made of metal, and a top handle 8 is arranged at the upper end of the pot cover 3. The edge of the pot cover 3 is sleeved with an insulation ring 9 that is attached to the pot body 2, effectively avoiding sparking phenomenon, and this can better keep the food in the pot 2 warm.

In a more preferred solution, the shell 1 is made of plastic material. When the pot body 2 is put into the shell 1, the ribs 7 are compressed by the pot body 2 and undergo slight deformation, allowing the ribs 7 to better clamp the pot body 2. When the pot body 2 is removed from the shell 1, the deformation of the ribs 7 is eliminated and recover to the original shape.

### Embodiment 2

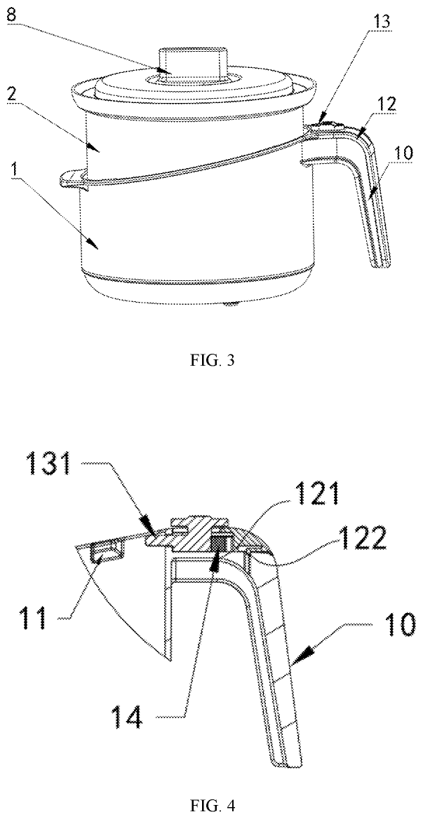

Please refer to FIGS. 3-5, a protrusion 11 is arranged on the inner wall of the shell 1, a handle 10 is arranged on the shell 1, a clamp is arranged on the handle 10, the fixing structure consists of the protrusion 11 and the clamp. The clamp includes an elastic member 14, a handle cover 12, and a substrate piece 13. The handle cover 12 is fixed on the handle 10, a first moving groove 124 is provided on the handle cover 12, the substrate piece 13 slides in the first moving groove 124, the tail end of the substrate piece 13 is connected to an elastic member 14, and the elastic member 14 pushes the substrate piece 13 towards the inner cavity of the pot body 2, such that the end of the substrate piece 13 passes through a first hole 101 of the pot body 2. The elastic member 14 may be made of materials with deformation characteristics such as spring, silicone rubber, soft plastic, etc. When the user slides the pressing part of the substrate piece 13 forward, the front end of the substrate piece 13 is pushed forward, and the protrusion 11 and the substrate piece 13 clamp the pot body 2 together, so that the pot body 2 is fixed inside the shell 1. When using the microwave pot, the air pressure inside the pot can be discharged through the gap among the protrusion 11, the substrate piece 13 and the pot body 2, ensuring the safety of user. When cleaning, the user can slide the pressing part of the substrate piece 13 backwards to retract the substrate 13, at this moment, a large gap between the shell 1 and the pot body 2 is existed, and the user can easily remove the pot body 2 from the shell 1 for easy cleaning of the microwave pot.

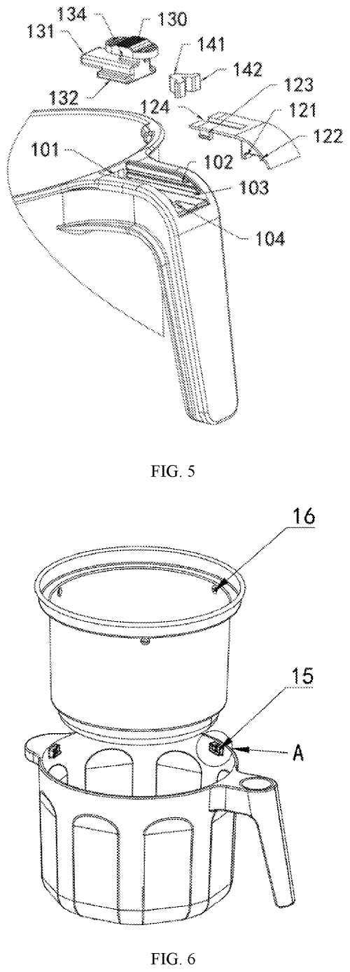

Please refer to FIG. 5, the handle cover 12 is used to seal a first chamber of the handle, and the two side walls of the first chamber are symmetrically provided with a second sliding groove 103. The substrate piece 13 includes a guide plate 132, an end plate 131, and a pressing part 130. The guide plate 132 is embedded in the second sliding groove 103 for sliding, the end of the end plate 131 is capable of reciprocating in the first hole 101, and the pressing part 130 is located above the first moving groove 124. A third sliding groove 102 is arranged above the second groove 103 in parallel, the left and right sides of the handle cover 12 is respectively provided with a first hook 123, the first hook 123 is hooked on the third sliding groove 102, a back plate 121 is provided at the rear of the handle cover 12, and the elastic member 14 presses against the back plate 121. As shown in the figures, the elastic member 14 is a V-shaped member, a fork end 142 of the elastic member 14 presses against the back plate 121, a tip end 141 of the elastic member 14 presses against the end plate 131. The bottom of the first chamber is provided with a positioning groove 104, and the positioning groove 104 is a groove that opens to the bottom wall. The handle cover 12 is provided with a second hook 122, and the function of the positioning groove 104 is to form a hook connection with the second hook 122, and to cooperate with the hook connection of the first hook 123 and the third sliding groove 102 to achieve the installation and fixation of the handle cover 12.

The connecting plate 134 is connected with the end plate 131 and the pressing part 130, and the connecting plate 134 is located in the first moving groove 124. Therefore, by pushing the pressing part 130, the end plate 131 presses backwards towards the elastic member 14, causing the end of the end plate 131 to retract into the first chamber and release the constraint on the pot body.

The structure of the pot body, pot lid, etc. is the same as in Embodiment 1, and will not be repeated here.

### Embodiment 3

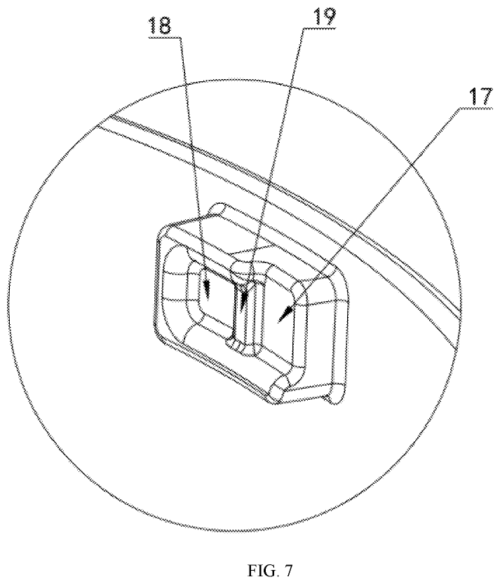

Please refer to FIGS. 6-7, a clamping part 15 is arranged on the inner wall of the shell 1. The clamping part 15 includes a first limiting groove 17 and a second limiting groove 18. A limiting protrusion 19 is arranged between the first limiting groove 17 and the second limiting groove 18. Flange portions 16 are arranged on the outer wall of the pot body. While in use, the user rotates the pot body 2 to allow the flange portion 16 on the outer wall of the pot body 2 to enter the first limiting groove 17 and touch the limiting protrusion 19. The limiting protrusions 19 and the flange portions are in contact, the user only needs to apply a little force to make the limiting protrusion undergo a small deformation, then the flange portion enters the second limiting groove 18 through the limiting protrusion 19, so that the flange portion is constrained in the second limiting groove 18, and the pot body is fixed in the shell. As the groove walls of the first limiting groove 17 and the second limiting groove 18 are higher than the inner wall of the shell, there is a large gap between the pot body 2 and the shell 1, therefore the gas generated during microwave heating can be discharged from this gap, enhancing the safety of the microwave pot. When cleaning the microwave pot, the user can rotate the pot body 2 in the opposite direction, making it easy to remove the pot body 2 for subsequent cleaning.

The above provides a detailed illustration of the embodiments of the present disclosure in conjunction with the accompanying drawings, but the present disclosure is not limited to the described embodiments. For those skilled in the art, various changes, modifications, substitutions, and variations of these embodiments without departing from the principles and spirit of the present disclosure still fall within the scope of the present disclosure.

What is claimed is:

1. A microwave pot, comprising: a shell, a pot body, and a pot cover used in conjunction with the pot body, wherein a fixing structure is arranged between the shell and the pot body, a microwave absorption layer is fixed on a bottom surface of the pot body, a gap is formed between the shell and the pot body by the fixing structure, and hot air between the shell and the pot body is discharged through the gap during microwave heating;
a clamping part is arranged on an inner wall of the shell, the clamping part comprises a first limiting groove and a second limiting groove, a limiting protrusion is arranged between the first limiting groove and the second limiting groove, flange portions are arranged on an outer wall of the pot body, the fixing structure consists of the clamping part and the flange portions.

2. The microwave pot according to claim 1, wherein the fixing structure is ribs provided at an inner wall of the shell, and the ribs are in contact with an outer surface of the pot body.

3. The microwave pot according to claim 1, wherein the pot cover is made of metal material, a top handle is arranged at an upper end of the pot cover, an edge of the pot cover is sleeved with an insulation ring that is attached to the pot body, and the microwave absorbing layer is covered with a silicone ring fastener.

4. The microwave pot according to claim 1, wherein the shell is made of plastic material, the fixing structure is ribs provided at the inner wall of the shell, and the ribs and the pot body are in an interference fit.

5. The microwave pot according to claim 1, wherein a handle is arranged on the shell, a clamp is arranged on the handle, the fixing structure consists of a protrusion and the clamp, the clamp comprises an elastic member, a handle cover, and a substrate piece, the handle cover is fixed on the handle, a first moving groove is provided on the handle cover, the substrate piece slides in the first moving groove, a tail end of the substrate piece is connected to an elastic member, and the elastic member pushes the substrate piece towards an inner cavity of the pot body, such that an end of the substrate piece passes through a first hole of the pot body.

6. The microwave pot according to claim 5, wherein the protrusion is provided on the inner wall of the shell, the handle cover is used to seal a first chamber of the handle, and two side walls of the first chamber are symmetrically provided with a second sliding groove; the substrate piece comprises a guide plate, an end plate, and a pressing part, the guide plate is embedded in the second sliding groove for sliding, an end of the end plate is capable of reciprocating in the first hole, and the pressing part is located above the first moving groove.

7. The microwave pot according to claim 6, wherein a third sliding groove is arranged above the second groove in parallel, left and right sides of the handle cover is respectively provided with a first hook, the first hook is hooked on the third sliding groove, a back plate is provided at a rear of the handle cover, and the elastic member presses against the back plate.

8. The microwave pot according to claim 7, wherein the elastic member is a V-shaped member, a fork end of the elastic member presses against the back plate, a tip end of the elastic member presses against the end plate, a bottom of the first chamber is provided with a positioning groove, and the handle cover is provided with a second hook capable of hooking onto the positioning groove.

9. The microwave pot according to claim 8, wherein the connecting plate is connected with the end plate and the pressing part, and the connecting plate is located in the first moving groove.
